(19) United States
(12) Patent Application Publication
(10) Pub. No.: US 2021/0349339 A1
(43) Pub. Date: Nov. 11, 2021

(54) ELECTRONIC DEVICE

(71) Applicant: InnoLux Corporation, Miao-Li County (TW)

(72) Inventors: Yu-Sheng HO, Miao-Li County (TW); Yi-Hsin CHEN, Miao-Li County (TW)

(21) Appl. No.: 17/215,866

(22) Filed: Mar. 29, 2021

(30) Foreign Application Priority Data
May 6, 2020 (CN) 202010374285.0

(51) Int. Cl. G02F 1/13363; G02F 1/1335

(52) U.S. Cl. CPC G02F 1/13363; G02F 1/133531

(57) ABSTRACT

An electronic device is provided, which includes a first phase retardation element, a second phase retardation element and a liquid-crystal layer. The second phase retardation element is disposed on the first phase retardation element, and the liquid-crystal layer is disposed between the first phase retardation element and the second phase retardation element. In addition, the liquid-crystal layer includes a chiral agent, and a pitch of the chiral agent is between 7 μm and 25 μm. The first phase retardation element has a first in-plane retardation value and a first out-plane retardation value, and the second phase retardation element has a second in-plane retardation value and a second out-plane retardation value. The first in-plane retardation value and the second in-plane retardation value are between 20 nanometers and 70 nanometers, and the first out-plane retardation value and the second out-plane retardation value are between 170 nanometers and 210 nanometers.

### CROSS REFERENCE TO RELATED APPLICATIONS

This application claims priority of China Patent Application No. 202010374285.0, filed on May 6, 2020, the entirety of which is incorporated by reference herein.

### BACKGROUND

### Technical Field

The present disclosure relates to an electronic device, and in particular it relates to an electronic device with a phase retardation element.

### Description of the Related Art

As electronic products—particularly high-resolution electronic products—have developed, consumers have come to have high expectations about the quality, functionality, and affordability of these electronic products. However, many such electronic devices are still inadequate in various respects. For example, obvious light leakage may occur at different viewing angles in the dark state or the panel's brightness may be uneven. Therefore, the development of structural designs that can further improve the quality or performance of electronic devices is still one of the current research topics in the industry.

### SUMMARY

In accordance with some embodiments of the present disclosure, an electronic device is provided. The electronic device includes a first phase retardation element, a second phase retardation element and a liquid-crystal layer. The second phase retardation element is disposed on the first phase retardation element, and the liquid-crystal layer is disposed between the first phase retardation element and the second phase retardation element. In addition, the liquid-crystal layer includes a chiral agent, and a pitch of the chiral agent is between 7 μm and 25 μm. The first phase retardation element has a first in-plane retardation value and a first out-plane retardation value, and the second phase retardation element has a second in-plane retardation value and a second out-plane retardation value. The first in-plane retardation value and the second in-plane retardation value are between 20 nanometers and 70 nanometers, and the first out-plane retardation value and the second out-plane retardation value are between 170 nanometers and 210 nanometers.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1 is a schematic diagram of a cross-sectional structure of an electronic device in accordance with some embodiments of the present disclosure;

FIG. 2 is a schematic diagram of a cross-sectional structure of an electronic device in accordance with some embodiments of the present disclosure;

FIG. 3 is a schematic diagram of a cross-sectional structure of an electronic device in accordance with some embodiments of the present disclosure;

FIG. 4 is a schematic diagram of a cross-sectional structure of an electronic device in accordance with some embodiments of the present disclosure;

FIG. 5 is a schematic diagram of a cross-sectional structure of an electronic device in accordance with some embodiments of the present disclosure;

FIG. 6 is a diagram of optical analysis results of an electronic device in accordance with some embodiments of the present disclosure;

FIG. 7 is a schematic diagram of a cross-sectional structure of an electronic device in accordance with some embodiments of the present disclosure;

FIG. 8 is a schematic top-view diagram of a sub-pixel area of an electronic device in accordance with some embodiments of the present disclosure;

FIG. 9 is a schematic top-view diagram of a sub-pixel area of an electronic device in accordance with some embodiments of the present disclosure;

FIG. 10 is a schematic diagram of a cross-sectional structure of an electronic device in accordance with some embodiments of the present disclosure.

### DETAILED DESCRIPTION

The electronic device of the present disclosure is described in detail in the following description. It should be understood that in the following detailed description, for purposes of explanation, numerous specific details and embodiments are set forth in order to implement various aspect of the embodiments of the present disclosure. The elements and configurations described in the following detailed description are set forth in order to clearly describe the present disclosure. It is apparent that these embodiments are used merely for the purpose of illustration and the present disclosure is not limited thereto. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments.

The present disclosure can be understood by referring to the following detailed description in connection with the accompanying drawings. It should be noted that, in order to allow the reader to easily understand the drawings, several drawings in the present disclosure only depict a portion of the display device, and the specific elements in the drawings are not drawn to scale. In addition, the number and size of each element in the drawings are only for illustration, and are not limited the scope of the present disclosure.

It should be noted that the elements or devices in the drawings of the present disclosure may be present in any form or configuration known to those with ordinary skill in the art. In addition, in the embodiments, relative expressions are used. For example, “lower”, “bottom”, “higher” or “top” are used to describe the position of one element relative to another. It should be appreciated that if a device is flipped upside down, an element that is “lower” will become an element that is “higher”. The present disclosure can be understood by referring to the following detailed description in connection with the accompanying drawings. The drawings are also regarded as part of the description of the present disclosure. Moreover, the expressions such as “first material layer disposed on/over a second material layer”, may indicate the direct contact of the first material layer and the second material layer, or it may indicate a non-contact state with one or more intermediate layers between the first material layer and the second material layer. In the above situation, the first material layer may not be in direct contact with the second material layer.

Throughout the present disclosure and the appended claims, certain terms are used to refer to specific elements. Those skilled in the art should understand that electronic device manufacturers may refer to the same element with different names. The present disclosure does not intend to distinguish between elements that have the same function but different names. In the specification and claims, the terms “comprising”, “including”, “having” and the like are open-ended phrases, so they should be interpreted as “including but is not limited to . . . ”. Therefore, when the terms “comprising”, “including” and/or “having” are used in the description of the present disclosure, they specify the corresponding features, regions, steps, operations and/or components, but do not exclude the existence of one or more corresponding features, regions, steps, operations and/or components.

Directional terms mentioned in the present disclosure, such as “upper”, “lower”, “front”, “rear”, “left”, “right”, etc., are only the directions referring to the drawings. Therefore, the directional terms are used for illustration, not for limiting the present disclosure. In the drawings, each drawing depicts general features of methods, structures, and/or materials used in particular embodiments. However, these drawings should not be interpreted as defining or limiting the scope or property encompassed by these embodiments. For example, for clarity, the relative sizes, thicknesses, and positions of the various layers, regions, and/or structures may be reduced or enlarged.

When the corresponding component (for example, a layer or region) is referred to as being “on another member”, it may be directly on the other member, or there may be other members between the two. On the other hand, when a component is referred to as being “directly on another component”, there is no component between the two. In addition, when one component is referred to as being “on the other component”, the two have an upper/lower relationship from a top view, and the one component can be above or below the other component, and such an upper/lower relationship depends on the orientation of the device.

In addition, it should be understood that, although the terms “first”, “second”, “third” etc. may be used herein to describe various elements, components, or portions, these elements, components, or portions should not be limited by these terms. These terms are only used to distinguish one element, component, area, layer, or portion from another element, component, area, layer, or portion. Thus, a first element, component, area, layer, or portion discussed below could be termed a second element, component, area, layer, or portion without departing from the teachings of the present disclosure.

The terms “about” and “substantially” typically mean +/−10% of the stated value, or typically +/−5% of the stated value, or typically +/−3% of the stated value, or typically +/−2% of the stated value, or typically +/−1% of the stated value or typically +/−0.5% of the stated value. The stated value of the present disclosure is an approximate value. When there is no specific description, the stated value includes the meaning of “about” or “substantially”. In addition, the term “in a range between the first value and the second value” means that the range includes the first value, the second value, and other values in between.

It should be noted that the following embodiments can replace, recombine, and mix features in several different embodiments to complete other embodiments without departing from the spirit of the present disclosure. The features between the various embodiments can be mixed and used arbitrarily as long as they do not violate or conflict the spirit of the present disclosure.

In the present disclosure, the thickness, length and width can be measured by an optical microscope, and the thickness can be measured from a cross-sectional image in an electron microscope, but it is not limited thereto. In addition, certain errors may exist between any two values or directions used for comparison. If the first value is equal to the second value, it implies that there may be an error of about 10% between the first value and the second value; if the first direction is perpendicular to the second direction, the angle between the first direction and the second direction may be between 80 degrees and 100 degrees; if the first direction is parallel to the second direction, the angle between the first direction and the second direction may be between 0 degrees and 10 degrees.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In accordance with some embodiments of the present disclosure, an electronic device including a phase retardation element is provided, and the in-plane retardation value (Ro) and the out-plane retardation value (Rth) of the phase retardation element are designed to be within a particular range that can improve the quality of the electronic device. For example, light leakage problem in the dark state or uneven brightness of the panel under different viewing angles can be improved. In accordance with some embodiments of the present disclosure, the electronic device may include a display device, a light-emitting device, a touch device, a sensing device, a tiled device, or a combination thereof, but it is not limited thereto. The electronic device may include a bendable or flexible electronic device. The electronic device may include, for example, a liquid-crystal device, but it is not limited thereto. In accordance with some embodiments, the electronic device may include a backlight module. The backlight module may include light-emitting diodes, such as inorganic light-emitting diodes, organic light-emitting diodes (OLEDs), mini light-emitting diodes (mini LEDs), micro light-emitting diodes (micro LEDs), quantum dot (QD) light-emitting diodes (for example, QLEDs or QDLEDs), fluorescence, phosphor, another suitable material, or a combination thereof, but it is not limited thereto. In the following, a display device will be used as an example to describe the electronic device, but the present disclosure is not limited thereto.

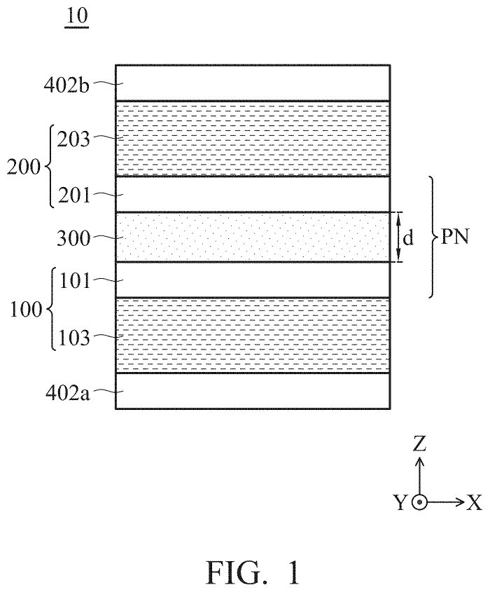

Refer to FIG. 1, which is a schematic diagram of a cross-sectional structure of an electronic device 10 in accordance with some embodiments of the present disclosure. It should be understood that, for clarity of description, some elements of the electronic device 10 are omitted in the drawing, and only some elements are schematically shown. In accordance with some embodiments, additional features can be added to the electronic device 10 described below. In accordance with some other embodiments, some of the features of the electronic device 10 described below may be replaced or omitted.

As shown in FIG. 1, the electronic device 10 may include a first phase retardation element 100, a second phase retardation element 200, and a liquid-crystal layer 300. The second phase retardation element 200 may be disposed on the first phase retardation element 100, and the liquid-crystal layer 300 may be disposed between the first phase retardation element 100 and the second phase retardation element 200.

In accordance with some embodiments, the first phase retardation element 100 and the second phase retardation element 200 may be used, for example, to change the polarization state of the light source, including changing the long axis direction of the polarization of light and/or the type of the polarization of light (for example, circular polarization, elliptical polarization, or linear polarization), but it is not limited thereto. In addition, the first phase retardation element 100 has a first in-plane retardation value (Ro-1) and a first out-plane retardation value (Rth-1), and the second phase retardation element 200 has a second in-plane retardation value (Ro-2) and a second out-plane retardation value (Rth-2). In accordance with some embodiments, the first in-plane retardation value and/or the second in-plane retardation value may be between 20 nanometers (nm) and 70 nanometers (i.e. 20 nm≤Ro-1≤70 nm, 20 nm≤Ro-2≤70 nm), or between 30 nm and 60 nm (i.e. 30 nm≤Ro-1≤60 nm, 30 nm≤Ro-2≤60 nm), for example, 35 nm, 40 nm, 45 nm, 50 nm, or 55 nm, but it is not limited thereto. In accordance with some embodiments, the first out-plane retardation value and/or the second out-plane retardation value may be between 170 nm and 210 nm (i.e. 170 nm≤Rth-1≤210 nm, 170 nm≤Rth-2≤210 nm), or between 180 nm and 200 nm (i.e. 180 nm≤Rth-1≤200 nm, 180 nm≤Rth-2≤200 nm), for example, 185 nm, 190 nm or 195 nm, but it is not limited thereto.

It should be noted that if the first in-plane retardation value and/or the second in-plane retardation value is too small or too large (for example, less than 20 nm or greater than 70 nm), the first phase retardation element 100 or the second phase retardation element 200 may not achieve a proper light compensation effect, and the problem of light leakage in the dark state is likely to occur under some viewing angles. Similarly, if the first out-plane retardation value and/or the second out-plane retardation value is too small or too large (for example, less than 170 nm or greater than 210 nm), the first phase retardation element 100 or the second phase retardation element 200 may not achieve a proper light compensation effect, and the problem of light leakage in the dark state is likely to occur under some viewing angles.

In accordance with some embodiments, the first in-plane retardation value of the first phase retardation element 100 and the second in-plane retardation value of the second phase retardation element 200 may be substantially the same. The first out-plane retardation value of the first phase retardation element 100 and the second out-plane retardation value of the second phase retardation element 200 may be substantially the same, but they are not limited thereto.

In accordance with some embodiments, the first phase retardation element 100 may be defined as all elements or layers between the liquid-crystal layer 300 and a first polarizing layer 402a, and the second phase retardation element 200 may be defined as all elements or layers between the liquid-crystal layer 300 and a second the polarizing layer 402b. Furthermore, the in-plane retardation value and the out-plane retardation value of the first phase retardation element 100 and the second phase retardation element 200 can be measured by a conventional instrument for phase difference measurement, such as Axometrics and/or the phase difference measuring device KOBRA [symbol] .

Referring to FIG. 1, in accordance with some embodiments, the first phase retardation element 100 may include a first substrate 101 and a phase retardation layer 103, and the first substrate 101 may be adjacent to the phase retardation layer 103. In addition, the second phase retardation element 200 may include a second substrate 201 and a phase retardation layer 203, and the second substrate 201 may be adjacent to the phase retardation layer 203, but it is not limited thereto.

In accordance with some embodiments, a panel PN may include the first substrate 101, the second substrate 201, and elements disposed between the first substrate 101 and the second substrate 201 (including the liquid-crystal layer 300). In accordance with some embodiments, the first substrate 101 may be used as a driving substrate, and the second substrate 201 may be used as a color filter layer substrate, but it is not limited thereto. The detailed configuration and structure of the first substrate 101 and the second substrate 201 will be further described later.

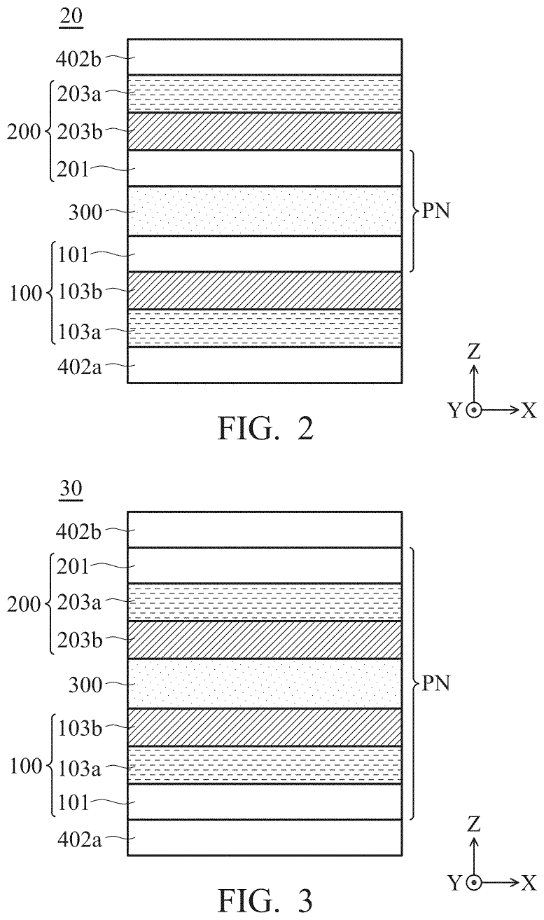

In accordance with some embodiments, the phase retardation layer 103 and/or the phase retardation layer 203 may include triacetyl cellulose (TAC), cyclic olefin copolymer (COP), liquid-crystal polymer (LCP), polymethyl methacrylate (PMMA), another suitable material, or a combination thereof, but it is not limited thereto. Furthermore, the phase retardation layer 103 and the phase retardation layer 203 may have a single-layer structure or a multi-layer structure (as shown in FIG. 2 to FIG. 5).

In accordance with some embodiments, the liquid-crystal layer 300 may include a liquid-crystal material, another suitable modulating material, or a combination thereof. In accordance with some embodiments, the liquid-crystal material may include nematic liquid crystal, smectic liquid crystal, cholesteric liquid crystal, blue phase liquid crystal, another suitable liquid-crystal material, or a combination thereof, but it is not limited thereto. The electronic device 10 may include a twisted nematic (TN) type liquid-crystal device, a super twisted nematic (STN) type liquid-crystal device, a double layer super twisted nematic (DSTN) type liquid-crystal device, a vertical alignment (VA) type liquid-crystal device, an in-plane switching (IPS) type liquid-crystal device, a cholesteric type liquid-crystal device, a blue phase type liquid-crystal device, a fringe field switching (FFS) type liquid-crystal device, a nano-protrusion vertical arrangement (NPVA) type liquid-crystal device, another suitable liquid-crystal device, or a combination thereof.

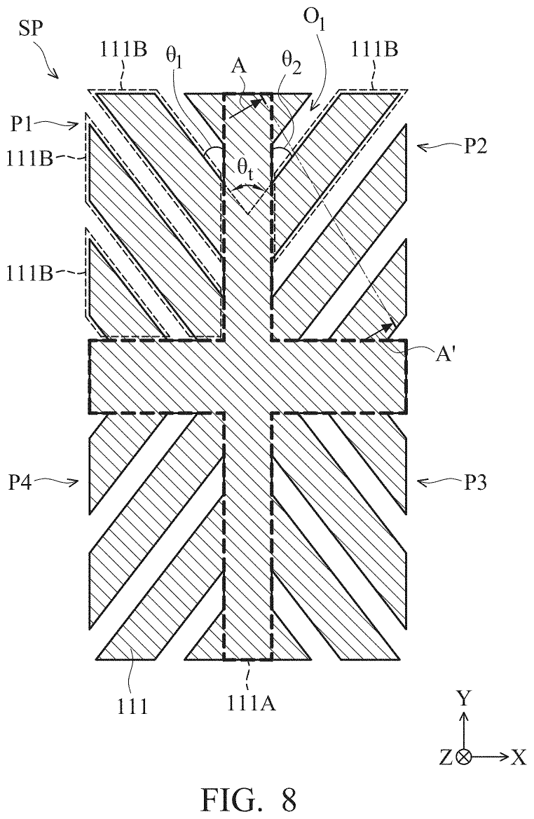

Moreover, the liquid-crystal layer 300 may include a chiral dopant. The chiral dopant may adjust the arrangement and/or rotation characteristics of the liquid-crystal molecules, so that the liquid-crystal molecules located in a certain area (such as the dark band area) can be rotated by the electric field to provide the phase retardation for the certain area (such as the dark band area). Therefore, the transmittance of the overall electronic device may be improved. The dark band area can be defined as the area where the liquid-crystal molecules rotate less (that is, providing less phase retardation) when a voltage is applied to the electronic device to form an electric field. For example, as shown in the following FIG. 8, the dark band area may substantially correspond to or overlap the area of the first electrode layer 111, but it is not limited thereto. The detailed arrangement position and pattern of the first electrode layer 111 will be described later. In accordance with some embodiments, a pitch P of the chiral agent (also referred to as chiral molecule) may be between 7 micrometers (μm) and 25 micrometers (i.e. 7 μm≤pitch P≤25 μm), or between 10 μm and 20 μm (i.e. 10 μm≤pitch P≤20 μm), for example, 11 μm, 12 μm, 13 μm, 14 μm, 15 μm, 16 μm, 17 μm, 18 μm or 19 μm, but it is not limited thereto. When the pitch P of the chiral agent is designed to be within the above range, the liquid-crystal molecules may have proper rotation, provide a better phase retardation. Therefore, the overall transmittance of the electronic device 10 may be improved. In accordance with some embodiments, a product value of the birefringence (Δn) of the liquid-crystal layer 300 and the thickness d of the liquid-crystal layer 300 may be between 300 nm and 550 nm (300 nm≤Δn·d≤550 nm), or between 320 nm and 380 nm (320 nm≤Δn·d≤380 nm) or between 440 nm and 500 nm (440 nm≤Δn·d≤500 nm), but it is not limited thereto. In accordance with some embodiments, a ratio of the thickness d to the pitch P may be between 0.15 and 0.35 (0.15≤d/p≤0.35), or between 0.2 and 0.3 (0.2≤d/p≤0.3), or between 0.23 and 0.28 (0.23≤d/p≤0.28), for example, 0.24 or 0.25, but it is not limited thereto.

In accordance with some embodiments, the aforementioned pitch P can be measured by a Grandjean-Cano wedge method, but it is not limited thereto.

In accordance with some embodiments, the aforementioned thickness d refers to the maximum thickness of the liquid-crystal layer 300 in a normal direction of the first substrate 101 (for example, the Z direction shown in the drawing).

In accordance with the embodiments of the present disclosure, an optical microscope (OM), a scanning electron microscope (SEM), a film thickness profiler (α-step), an ellipsometer or another suitable method may be used to measure the thickness or width of each element, or the distance between elements. Specifically, in accordance with some embodiments, after the liquid-crystal layer 300 is removed, a scanning electron microscope may be used to obtain any cross-sectional image including the elements to be measured, and the thickness or width of each element, or the distance between elements in the image can be measured.

As shown in FIG. 1, in accordance with some embodiments, the electronic device 10 may further include a first polarizing layer 402a and a second polarizing layer 402b. The first polarizing layer 402a may be adjacent to the first phase retardation element 100, and the second polarizing layer 402b may be adjacent to the second phase retardation element 200. In accordance with some embodiments, the first phase retardation element 100, the second phase retardation element 200, and the liquid-crystal layer 300 may be disposed between the first polarizing layer 402a and the second polarizing layer 402b.

In accordance with some embodiments, the first polarizing layer 402a and/or the second polarizing layer 402b may include a polyvinyl alcohol (PVA) film, a tri-acetyl cellulose (TAC) film, a pressure sensitive adhesive film, a protective film and/or a release film, another suitable polarizing material, or a combination thereof, but it is not limited thereto.

In accordance with some embodiments, the aforementioned elements may be optionally adhered together by an adhesion process. For example, the phase retardation layer 103 may be adhered to the first substrate 101, the phase retardation layer 203 may be adhered to the second substrate 201, the phase retardation layer 103 may be adhered to the first polarizing layer 402a, or the phase retardation layer 203 may be adhered to the second polarizing layer 402b. In other words, there may be optionally an adhesive layer (not illustrated) existing between the aforementioned elements. In accordance with some other embodiments, a stacked structure of the aforementioned elements may be sequentially formed by a coating process, a chemical deposition process, a printing process, another suitable process, or a combination thereof.

Refer to FIG. 2, which is a schematic diagram of a cross-sectional structure of an electronic device 20 in accordance with some other embodiments of the present disclosure. It should be understood that the same or similar components or elements in the following context will be denoted by the same or similar reference numbers, and their materials, manufacturing methods and functions are the same or similar to those described above, and thus they will not be repeated in the following context.

As shown in FIG. 2, in accordance with some embodiments, the first phase retardation element 100 and the second phase retardation element 200 may have composite layers, for example, may have multi-layered phase retardation layers. Specifically, in accordance with some embodiments, the first phase retardation element 100 may include a first phase retardation layer 103a and/or a second phase retardation layer 103b, and the second phase retardation element 200 may include a third phase retardation layer 203a and/or a fourth phase retardation layer 203b. The first phase retardation layer 103a may be located between the second phase retardation layer 103b and the first polarizing layer 402a, and the third phase retardation layer 203a may be located between the fourth phase retardation layer 203b and the second polarizing layer 402b.

As shown in FIG. 2, in accordance with some embodiments, the above-mentioned phase retardation layer may be disposed on the outer sides of the first substrate 101 and/or the second substrate 201. That is, the above-mentioned phase retardation layer may be disposed on the outer sides of the panel PN, and may be the out-cell phase retardation layers. In accordance with some embodiments, the panel PN may include the first substrate 101, the second substrate 201, and the liquid-crystal layer 300 disposed between the first substrate 101 and the second substrate 201.

In accordance with some embodiments, the first phase retardation element 100 may be disposed between the first polarizing layer 402a and the liquid-crystal layer 300. In accordance with some embodiments, the second phase retardation element 200 may be disposed between the second polarizing layer 402b and the liquid-crystal layer 300. In accordance with some embodiments, the first phase retardation element 100 may include the first substrate 101, the first phase retardation layer 103a and/or the second phase retardation layer 103b, the first phase retardation layer 103a may be disposed between the first substrate 101 and the liquid-crystal layer 300, and the second phase retardation layer 103b may be disposed between the first phase retardation layer 103a and the liquid-crystal layer 300. In accordance with some embodiments, the second phase retardation element 200 may include the second substrate 201, the third phase retardation layer 203a and/or the fourth phase retardation layer 203b, the third phase retardation layer 203a may be disposed on the second substrate 201 and the liquid-crystal layer 300, and the fourth phase retardation layer 203b may be disposed between the third phase retardation layer 203a and the liquid-crystal layer 300.

In accordance with some embodiments, the material of the first phase retardation layer 103a, the second phase retardation layer 103b, the third phase retardation layer 203a and/or the fourth phase retardation layer 203b may be similar to that of the aforementioned phase retardation layer 103 and phase retardation layer 203, and thus will not be repeated herein. In accordance with some embodiments, the first phase retardation layer 103a and the third phase retardation layer 203a may be formed of the same material, the second phase retardation layer 103b and the fourth phase retardation layer 203b may be formed of the same material, and the first phase retardation layer 103a and the second phase retardation layer 103b may be formed of different materials. That is, the electronic device 20 may have a substantially symmetrical (based on the liquid-crystal layer 300) stacked structure, but it is not limited thereto. In accordance with some embodiments (not illustrated), the first phase retardation layer 103a and the fourth phase retardation layer 203b may be formed of the same material, the second phase retardation layer 103b and the third phase retardation layer 203a may be formed of the same material, and the first phase retardation layer 103a and the second phase retardation layer 103b may be formed of different materials, but it is not limited thereto. In accordance with some embodiments, the materials of the first phase retardation layer 103a, the second phase retardation layer 103b, the third phase retardation layer 203a, and the fourth phase retardation layer 203b may be partly the same or partly different, or all the same or all different.

It should be understood that the number and/or arrangement of phase retardation layers are not limited to those shown in the drawings. In accordance with some embodiments, the first phase retardation element 100 and the second phase retardation element 200 may have a different number of phase retardation layers (for example, two layers, three layers, four layers, but it is not limited thereto). In addition, the first phase retardation element 100 and the second phase retardation element 200 may have the same or different numbers of phase retardation layers, as long as the first phase retardation element 100 and the second phase retardation element 200 have the above-mentioned in-plane retardation value and out-plane retardation value. For example, the first in-plane retardation value and/or the second in-plane retardation value may be between 20 nm and 70 nm (20 nm≤Ro-1≤70 nm, 20 nm≤Ro-2≤70 nm), and the first out-plane retardation value and/or the second out-plane retardation value may be between 170 nm and 210 nm (170 nm≤Rth-1≤210 nm, 170 nm≤Rth-2≤210 nm).

Refer to FIG. 3, which is a schematic diagram of a cross-sectional structure of an electronic device 30 in accordance with some other embodiments of the present disclosure. As shown in FIG. 3, in accordance with some embodiments, the first phase retardation element 100 and/or the second phase retardation element 200 may have composite layers, for example, may have multi-layered phase retardation layers, and these phase retardation layers may be disposed on the inner sides of the first substrate 101 and the second substrate 201. That is, these phase retardation layers may be disposed on the inner sides of the panel PN, and may be the in-cell phase retardation layers. In the embodiment shown in FIG. 3, the panel PN includes the first substrate 101, the second substrate 201, and the first phase retardation layer 103a, the second phase retardation layer 103b, the liquid-crystal layer 300, the third phase retardation layer 203a and/or the fourth phase retardation layer 203b disposed between the first substrate 101 and the second substrate 201, but it is not limited thereto.

In accordance with some embodiments, the first phase retardation layer 103a and the second phase retardation layer 103b may be disposed between the first substrate 101 and the liquid-crystal layer 300. In accordance with some embodiments, the third phase retardation layer 203a and the fourth phase retardation layer 203b may be disposed between the second substrate 201 and the liquid-crystal layer 300. In accordance with some embodiments, the materials of the first phase retardation layer 103a, the second phase retardation layer 103b, the third phase retardation layer 203a and/or the fourth phase retardation layer 203b may include liquid-crystal polymer (LCP). The phase retardation layer formed of liquid-crystal polymers as described above may be disposed between the liquid-crystal layer 300 and the first substrate 101, or in any layer structure between the liquid-crystal layer 300 and the second substrate 201. In accordance with some embodiments, the phase retardation layer formed of liquid-crystal polymers may optionally have different thicknesses corresponding to the sub-pixels of different colors (such as red, blue and/or green, but it is not limited thereto). For example, the thickness of the thickness may be referred to the maximum thickness of the layer in the SEM image measured by a scanning electron microscope.

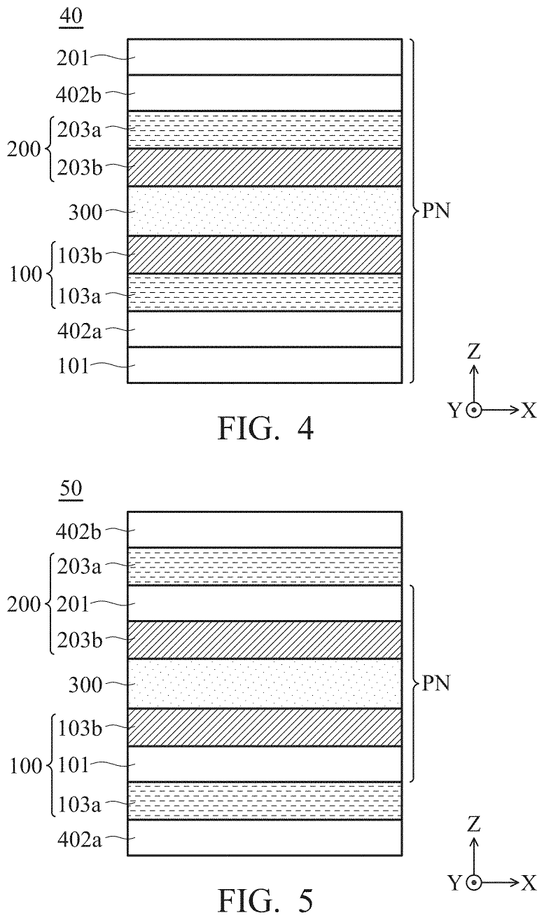

Refer to FIG. 4, which is a schematic diagram of a cross-sectional structure of an electronic device 40 in accordance with some other embodiments of the present disclosure. As shown in FIG. 4, in accordance with some embodiments, the first phase retardation element 100, the second phase retardation element 200, the first polarizing layer 402a and/or the second polarizing layer 402b may be disposed on the inner sides of the first substrate 101 and the second substrate 201, and the polarizing layer also may be disposed on the inner sides of the panel PN, which may be the in-cell phase retardation layers. In accordance with the embodiment shown in FIG. 4, the panel PN may include the first substrate 101, the second substrate 201, and the first polarizing layer 402a, the first phase retardation layer 103a, the second phase retardation layer 103b, the liquid-crystal layer 300, the second polarizing layer 402b, the third phase retardation layer 203a and/or the fourth phase retardation layer 203b disposed between the first substrate 101 and the second substrate 201, but it is not limited thereto.

In accordance with some embodiments, the first phase retardation element 100 may be disposed between the liquid-crystal layer 300 and the first polarizing layer 402a. In accordance with some embodiments, the second phase retardation element 200 may be disposed between the liquid-crystal layer 300 and the second polarizing layer 402b. In accordance with some embodiments, the first polarizing layer 402a may be disposed between the first phase retardation element 100 and the first substrate 101. In accordance with some embodiments, the second polarizing layer 402b may be disposed between the second phase retardation element 200 and the second substrate 201. The first polarizing layer 402a and/or the second polarizing layer 402b in the embodiment of FIG. 4 may include, for example, a periodic metal (nano) wire grid plate (WGP), but it is not limited thereto.

Refer to FIG. 5, which is a schematic diagram of a cross-sectional structure of an electronic device 50 in accordance with some other embodiments of the present disclosure. As shown in FIG. 5, in accordance with some embodiments, the first phase retardation element 100 and the second phase retardation element 200 may be partly disposed within the panel PN, and may be partly disposed on the outer sides of the panel PN. For example, the second phase retardation layer 103b of the first phase retardation element 100 and the fourth phase retardation layer 203b of the second phase retardation element 200 may be disposed on the inner sides of the panel PN (i.e. the inner sides of the first substrate 101 and the second substrate 201). In accordance with some embodiments, the first phase retardation layer 103a of the first phase retardation element 100 and the third phase retardation layer 203a of the second phase retardation element 200 may be disposed on the outer sides of the panel PN (i.e. disposed on the outer sides of first substrate 101 and the second substrate 201, respectively). In other words, the first phase retardation layer 103a and the second phase retardation layer 103b of the first phase retardation element 100 may be respectively disposed on both sides of the first substrate 101. In accordance with some embodiments, the third phase retardation layer 203a and the fourth phase retardation layer 203b of the second phase retardation element 200 may be respectively disposed on both sides of the second substrate 201. In accordance with the embodiment shown in FIG. 5, the panel PN may include the first substrate 101, the second substrate 201, and the second phase retardation layer 103b, the liquid-crystal layer 300, and/or the fourth phase retardation layer 203b disposed between the first substrate 101 and the second substrate 201.

In accordance with some embodiments (not illustrated), the first phase retardation element 100 may be partly disposed within the panel PN and partly disposed outside the panel PN, and the second phase retardation element 200 may be entirely disposed within the panel PN, but it is not limited thereto. In other words, one of the first phase retardation layer 103a and the second phase retardation layer 103b may be disposed between the first substrate 101 and the liquid-crystal layer 300, and the third phase retardation layer 203a and the fourth phase retardation layer 203b both may be disposed between the second substrate 201 and the liquid-crystal layer 300. In summary, the first phase retardation element 100 and/or the second phase retardation element 200 may be optionally entirely disposed outside the panel PN, entirely disposed within the panel PN, or partly disposed within the panel PN and partly disposed outside the panel PN.

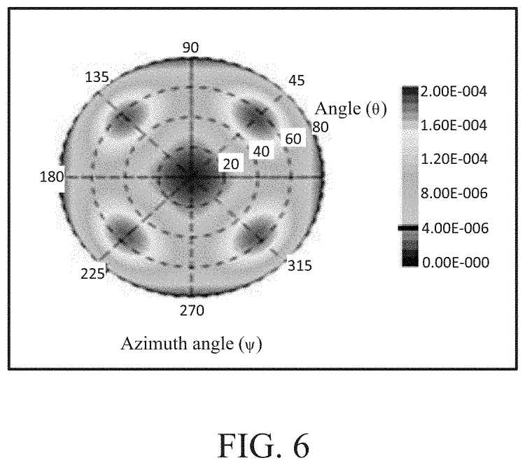

Refer to FIG. 6, which is a diagram of optical analysis results of an electronic device in accordance with some embodiments of the present disclosure. The optical analysis result is, for example, the result measured when the electronic device is in a dark state. The optical analysis result can be measured or analyzed using, for example, a conoscopic lens measurement device or another suitable instrument, but it is not limited thereto. Specifically, as shown in FIG. 6, the color scale on the right represents different brightness per unit area (cd/m²), and the result on the left shows the brightness per unit area (cd/m²) corresponding to different angles θ and azimuth angle φ. The angle θ is, for example, the included angle between the measurement direction and the normal direction Z of the panel PN. The azimuth angle φ is, for example, the angle of the measurement direction in a direction that is parallel to the upper surface of the panel PN. As shown in FIG. 6, it can be seen that when the angle θ is in a range from 0 degree (i.e. including the center point) to 20 degrees, and the azimuth angle φ is between 0 and 360 degrees, the brightness per unit area (cd/m²) is in a range from about 0 cd/m² to about 4E-006 cd/m². When the angle θ is in a range from 20 degrees to 40 degrees, and the azimuth angle φ is between 0 and 360 degrees, the brightness per unit area (cd/m²) is in a range from about 4E-006 cd/m² to about 1.2E-004 cd/m². When the angle θ is in a range from 40 degrees to 80 degrees and in most ranges of the azimuth angle φ (for example, the azimuth angle φ is between about 0 degree and about 22.5 degrees, between about 67.5 degrees and about 112.5 degrees, between about 172.5 degrees and about 202.5 degrees and/or between about 247.5 degrees and about 292.5 degrees), the brightness per unit area (cd/m²) is within about 1.2E-004 cd/m². When the angle θ is in the range from 40 degrees to 80 degrees and in other ranges of the azimuth angle φ (the range of the azimuth angle φ other than the above), the brightness per unit area (cd/m²) is in a range from about 1.6E-004 cd/m² to 2.0E-004 cd/m², but it is not limited thereto. It can be known that the light leakage problem of this electronic device in the dark state under different viewing angles is not obvious. It should be understood that the range of the brightness value per unit area (cd/m²) of the aforementioned electronic device is merely the result of a certain embodiment, but the present disclosure is not limited thereto. The brightness value per unit area may vary, depending on the design of the panel PN, or the material of the liquid-crystal layer 300.

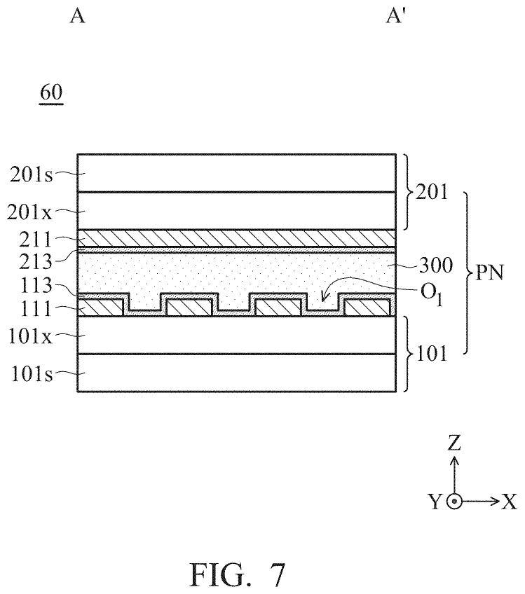

Refer to FIG. 7, which is a schematic diagram of a cross-sectional structure of an electronic device 60 in accordance with some other embodiments of the present disclosure. FIG. 7 illustrates the detailed structure of the panel PN in accordance with some embodiments. It should be understood that, in FIG. 7, the panel PN includes the first substrate 101, the second substrate 201 and the liquid-crystal layer 300 as an example. In the embodiment where the panel PN further includes other elements, the arrangement of the structure can be adjusted accordingly.

As shown in FIG. 7, in accordance with some embodiments, the second substrate 201 may be opposite to the first substrate 101, and the liquid-crystal layer 300 may be disposed between the first substrate 101 and the second substrate 201. As described above, the first substrate 101 may serve as a driving substrate, and the first substrate 101 may include a first base 101s and a circuit layer 101x. The circuit layer 101x may be disposed on the first base 101s, and the circuit layer 101x may be disposed between the first base 101s and the liquid-crystal layer 300.

In accordance with some embodiments, the first base 101s may include a flexible substrate, a rigid substrate, or a combination thereof. In accordance with some embodiments, the material of the first base 101s may include glass, quartz, sapphire, ceramic, polyimide (PI), liquid-crystal polymer (LCP) material, polycarbonate (PC), photo sensitive polyimide (PSPI), polyethylene terephthalate (PET), another suitable material, or a combination thereof, but it is not limited thereto.

In accordance with some embodiments, the circuit layer 101x may include a driving circuit, and the driving circuit may, for example, include an active driving circuit and/or a passive driving circuit. In accordance with some embodiments, the driving circuit may include transistors (for example, switching transistors or driving transistors, etc.), data lines, scan lines, conductive pads, dielectric layers or other circuits, etc., but it is not limited thereto.

In accordance with some embodiments, the first electrode layer 111 and a first alignment layer 113 may be sequentially disposed on the circuit layer 101x. The first electrode layer 111 and the first alignment layer 113 may be disposed between the first substrate 101 and the liquid-crystal layer 300, and the first electrode layer 111 may be electrically connected to the circuit layer 101x. In accordance with some embodiments, the first electrode layer 111 may be patterned to have a plurality of first openings O₁. In accordance with some embodiments, the first alignment layer 113 may be conformally formed on the first electrode layer 111 and in the first openings O₁.

In accordance with some embodiments, the material of the first electrode layer 111 may include a metal conductive material, a transparent conductive material, another suitable material, or a combination thereof, but it is not limited thereto. The metal conductive material may include copper (Cu), silver (Ag), tin (Sn), aluminum (Al), molybdenum (Mo), tungsten (W), gold (Au), chromium (Cr), nickel (Ni), platinum (Pt), titanium (Ti), any of the foregoing metal alloys, another suitable material, or a combination thereof, but it is not limited thereto. The transparent conductive material may include indium tin oxide (ITO), tin oxide (SnO), zinc oxide (ZnO), indium zinc oxide (IZO), indium gallium zinc oxide (IGZO), indium tin zinc oxide (ITZO), antimony tin oxide (ATO), antimony zinc oxide (AZO), another suitable material, or a combination thereof, but it is not limited thereto.

As described above, the second substrate 201 may serve as a color filter layer substrate. In accordance with some embodiments, the second substrate 201 may include a second base 201s and a color filter layer 201x, and the color filter layer 201x may be disposed on the second base 201, and between the second base 201s and the liquid-crystal layer 300. In accordance with some embodiments, the second substrate 201 may also include a light-shielding layer (not illustrated), and the light shielding layer may be disposed between the color filter units (not illustrated) of the color filter layer 201x. The material of the second base 201s may be similar to the material of the first base 101s, and thus will not be repeated herein. The material of the second base 201s may be the same as or different from the material of the first base 101s. In accordance with some embodiments, a second electrode layer 211 and a second alignment layer 213 may be sequentially disposed on the color filter layer 201x, and the second electrode layer 211 and the second alignment layer 213 may be disposed between the second substrate 201 and the liquid-crystal layer 300.

In accordance with some embodiments, the second electrode layer 211 might not be patterned: That is, the second electrode layer 211 may not have an opening. Furthermore, the material of the second electrode layer 211 may be similar to the material of the first electrode layer 111, and thus will not be repeated herein. In addition, the material of the second electrode layer 211 may be the same as or different from the material of the first electrode layer 111.

Refer to FIG. 8, which is a schematic top-view diagram of a sub-pixel area SP of the electronic device 60 in accordance with some embodiments of the present disclosure. The section line A-A′ in FIG. 8 may correspond to the cross-sectional structure shown in FIG. 7. It should be understood that, for clarity of description, FIG. 8 merely illustrates the first electrode layer 111, and other elements are omitted. The electronic device 60 may actually have a plurality of sub-pixel regions SP, and FIG. 8 only illustrates one of them.

As shown in FIG. 8, the first electrode layer 111 may be correspondingly disposed in the sub-pixel area SP of the electronic device 60. As described above, the first electrode layer 111 may be patterned to have a plurality of first openings O₁. In accordance with some embodiments, the patterned first electrode layer 111 may have a main portion 111A and a plurality of branch portions 111B. The main portion 111A may divide the first electrode layer 111 into a first portion P1, a second portion P2, a third portion P3 and a fourth portion P4, and for example, the first portion P1, the second portion P2, the third portion P3 and the fourth portion P4 may be arranged in a clockwise manner. As shown in FIG. 8, the second portion P2 and the fourth portion P4 may be adjacent to the first portion P1, and the third portion P3 and the first portion P1 may be arranged substantially diagonally. In accordance with some embodiments, there may be more or fewer portions. In accordance with some embodiments, the main portion 111A may have a cross shape, but it is not limited thereto. In accordance with some embodiments, the plurality of branch portions 111B may be connected to the main portion 111A and extend away from the main portion 111A, but it is not limited thereto.

In accordance with some embodiments, a first included angle θ₁ may exist between one of the branch portions 111B corresponding to the first portion P1 and the main portion 111A, a second included angle θ₂ may exist between one of the branch portions 111B corresponding to the second portion P2 and the main portion 111A. In accordance with some embodiments, the first included angle θ₁ and the second included angle θ₂ may be substantially the same. In accordance with some embodiments, the first included angle θ1 and/or the second included angle θ2 may be between 40 degrees and 50 degrees (40 degrees≤first included angle θ1≤50 degrees; 40 degrees≤second included angle θ2≤50 degrees), or between 42 degrees and 48 degrees (42 degrees≤first included angle 01≤48 degrees; 42 degrees ≤second included angle θ₂≤48 degrees), for example, 45 degrees. It should be noted that the first included angle θ₁ and the second included angle θ₂ are referred to as the angles formed between the corresponding branch portion 111B (e.g., its extension surface) and the long axis of the main portion 111A (the portion extending along the Y direction in the drawing). In accordance with some embodiments, an included angle θₜ may exist between one of the branch portions 111B corresponding to the first portion P1 and one of the branch portions 111B corresponding to the adjacent second portion P2 (i.e. the included angle θₜ may be regarded as the sum of the first included angle θ₁ and the second included angle θ₂). In accordance with some embodiments, the included angle θₜ may be between 80 degrees and 100 degrees (80 degrees≤included angle θₜ≤100 degrees), or between 85 degrees and 95 degrees (85 degrees≤included angle θₜ≤95 degrees), for example, 90 degrees.

It should be noted that, as shown in FIG. 8, the term included angle θₜ refers to the angle formed by the intersection of the extension surface of the first portion P1 and the extension surface of the branch portion 111B of the second portion P2.

Referring to FIG. 8, in accordance with some embodiments, taking the long axis of the main portion 111A (the portion extending along the Y direction in the drawing) as a reference, the branch portion 111B of the first portion P1 and the branch portion 111B of the second portion P2 may be substantially symmetrical. In accordance with some embodiments, taking the long axis of the main portion 111A as a reference, the branch portion 111B of the third portion P3 and the branch portion 111B of the fourth portion P4 may be substantially symmetrical. In accordance with some embodiments, taking the short axis of the main portion 111A (the portion extending along the X direction in the drawing) as a reference, the branch portion 111B of the first portion P1 and the branch portion 111B of the fourth portion P4 may be substantially symmetrical. In accordance with some embodiments, taking the short axis of the main portion 111A as a reference, the branch portion 111B of the second portion P2 and the branch portion 111B of the third portion P3 may be substantially symmetrical. The above-mentioned term “symmetrical” may include, for example, that the included angle between the branch portion 111B and the main portion 111A is substantially the same, the width of the branch portions 111B and/or the distance between adjacent branch portions 111B are substantially the same, but it is not limited thereto.

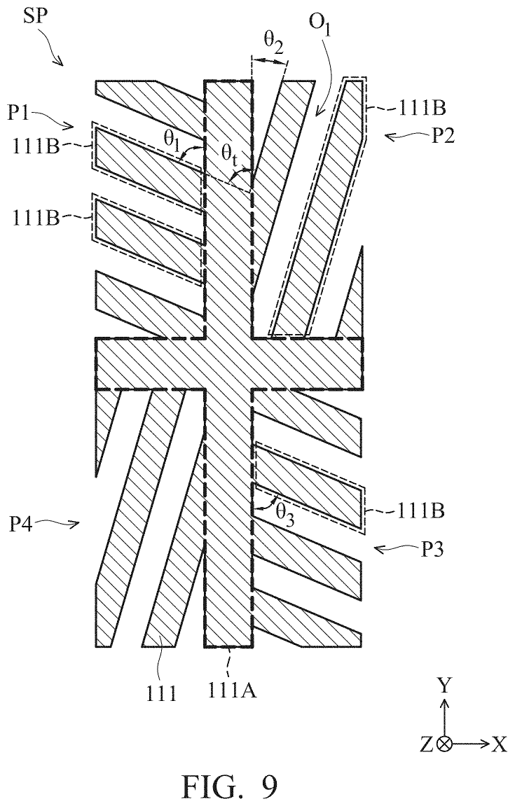

Refer to FIG. 9, which is a schematic top-view diagram of a sub-pixel area SP of the electronic device 60 in accordance with some other embodiments of the present disclosure. The embodiment shown in FIG. 9 is similar to the embodiment shown in FIG. 8. One of the differences between them is that the extension direction of the branch portions 111B of the first electrode layer 111 in FIG. 9 is different from that in FIG. 8.

As shown in FIG. 9, in accordance with some embodiments, the first included angle θ₁ may exist between one of the branch portions 111B corresponding to the first portion P1 and the main portion 111A, the second included angle θ₂ may exist between one of the branch portions 111B corresponding to the second portion P2 and the main portion 111A, a third included angle θ₃ may exist between one of the branch portions 111B corresponding to the third portion P3 and the main portion 111A, and a fourth included angle θ₄ may exist between one of the branch portions 111B corresponding to the fourth portion P4 and the main portion 111A. Furthermore, the definitions of the third included angle θ₃ and the fourth included angle θ₄ are similar to the aforementioned definitions of the first included angle θ₁ and the second included angle θ₂, and thus will not be repeated herein. In accordance with some embodiments, the first included angle this not equal to the second included angle θ₂. In accordance with some embodiments, the third included angle θ₃ is not equal to the fourth included angle θ₄. In accordance with some embodiments, the angle θₜ may exist between one of the branch portions 111B corresponding to the first portion P1 (e.g., its extension surface) and one of the branch portions 111B corresponding to the adjacent second portion P2 (e.g., its extension surface) (i.e. the angle θₜ may be regarded as the sum of the first included angle θ₁ and the second included angle θ₂). In accordance with some embodiments, the included angle θₜ may be between 80 degrees and 100 degrees (80 degrees≤included angle θₜ≤100 degrees), or between 85 degrees and 95 degrees (85 degrees≤included angle θₜ≤95 degrees), for example, 90 degrees. In accordance with some embodiments, an included angle (not illustrated) may exist between one of the branch portions 111B corresponding to the third portion P3 (e.g., its extension surface) and one of the branch portions 111B corresponding to the adjacent fourth portion P4 (e.g., its extension surface) (i.e. the included angle may be regarded as the sum of the third included angle θ₃ and the fourth included angle θ₄). In accordance with some embodiments, the range of this included angle may be similar to that of the included angle θₜ. In accordance with some embodiments, the first included angle θ₁ may be between 45 degrees and 75 degrees (45 degrees≤first included angle θ₁≤75 degrees), and the second included angle θ₂ may be between 15 degrees and 45 degrees (15 degrees≤second included angle θ₂≤45 degrees).

As shown in FIG. 9, in accordance with some embodiments, the third included angle θ₃ may be substantially equal to the first included angle θ₁. In accordance with some embodiments, the second included angle θ₂ may be substantially equal to the fourth included angle θ₄. In accordance with some embodiments, taking the long axis of the main portion 111A (e.g., the portion extending along the Y direction in the drawing) as a reference, the branch portion 111B of the first portion P1 and the branch portion 111B of the second portion P2 may be asymmetrical. In accordance with some embodiments, taking the long axis of the main portion 111A as a reference, the branch portion 111B of the third portion P3 and the branch portion 111B of the fourth portion P4 may be asymmetric. In accordance with some embodiments, taking the short axis of the main portion 111A as a reference, the branch portion 111B of the first portion P1 and the branch portion 111B of the fourth portion P4 may be asymmetric. In accordance with some embodiments, taking the short axis of the main portion 111A (e.g., the portion extending along the X direction in the drawing) as a reference, the branch portion 111B of the second portion P2 and the branch portion 111B of the third portion P3 may be asymmetric.

Compared with the first electrode layer 111 shown in FIG. 8, the extension direction of the branch portion 111B of the first electrode layer 111 in FIG. 9 is adjusted in a counterclockwise manner. That is, the extension directions of the branch portions 111B located in different portions (for example, the first portion P1, the second portion P2, the third portion P3, and the fourth portion P4) are all adjusted counterclockwise by about 5 degrees to about 45 degrees, or about 5 degrees to about 30 degrees, but it is not limited thereto. In accordance with some embodiments, when the chiral agent can rotate the liquid-crystal molecules in a clockwise direction, the first electrode layer 111 design shown in FIG. 9, in which the extension direction of the branch portion 111B of the first electrode layer 111 is adjusted in a counterclockwise manner, can be selected, thereby achieving improved transmittance, but it is not limited thereto. In accordance with some other embodiments (not illustrated), compared with the first electrode layer 111 shown in FIG. 8, the extension direction of the branch portion 111B of the first electrode layer 111 can be adjusted in a clockwise manner. That is, the extension directions of the branch portions 111B located in different portions (for example, the first portion P1, the second portion P2, the third portion P3, and the fourth portion P4) are all adjusted clockwise by about 5 degrees to about 45 degrees, or about 5 degrees to about 30 degrees, but it is not limited thereto. In accordance with some embodiments, when the chiral agent can rotate the liquid-crystal molecules in a counterclockwise direction, the first electrode layer 111 design in which the extension direction of the branch portion 111B of the first electrode layer 111 is adjusted in a clockwise manner can be selected, thereby achieving improved transmittance, but it is not limited thereto.

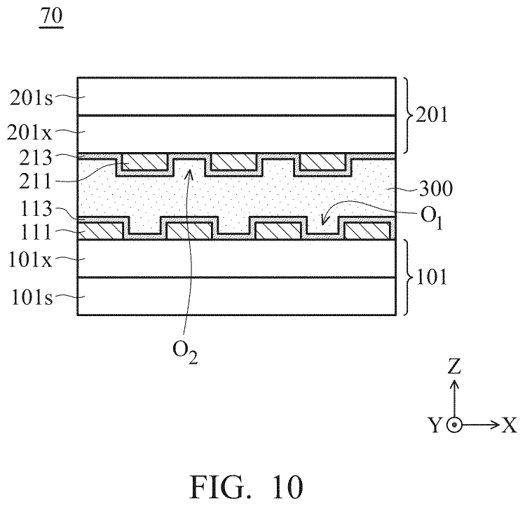

Refer to FIG. 10, which is a schematic diagram of a cross-sectional structure of an electronic device 70 in accordance with some other embodiments of the present disclosure. The embodiment shown in FIG. 10 is similar to the embodiment shown in FIG. 7. One of the differences between them is that, in FIG. 10, the second electrode layer 211 of the electronic device 70 may be patterned to have a plurality of second openings O₂. In accordance with some embodiments, the second alignment layer 213 may be conformally formed on the second electrode layer 211 and in the second openings O₂. In accordance with some embodiments, in the normal direction of the first substrate 101 (such as the Z direction shown in the drawing), the second electrode layer 211 may overlap the first opening O₁, or the first electrode layer 111 may overlap the second openings O₂. In accordance with some embodiments, the width of the second opening O₂ may be the same as or different from and the width of the first opening O₁.

To summarize the above, in accordance with some embodiments of the present disclosure, the electronic device provided includes the first phase retardation element and the second phase retardation element, and the respective in-plane retardation value (Ro) and the out-plane retardation value (Rth) of the first phase retardation element and the second phase retardation element are designed to be within a particular range that can improve the quality of the electronic device. For example, light leakage problem in the dark state or uneven brightness of the panel under different viewing angles can be improved.

Although some embodiments of the present disclosure and their advantages have been described in detail, it should be understood that various changes, substitutions and alterations can be made herein without departing from the spirit and scope of the disclosure as defined by the appended claims. The features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps. In addition, each claim constitutes an individual embodiment, and the claimed scope of the present disclosure includes the combinations of the claims and embodiments. The scope of protection of present disclosure is subject to the definition of the scope of the appended claims. Any embodiment or claim of the present disclosure does not need to meet all the purposes, advantages, and features disclosed in the present disclosure.

What is claimed is:

1. An electronic device, comprising:
a first phase retardation element;
a second phase retardation element disposed on the first phase retardation element; and
a liquid-crystal layer disposed between the first phase retardation element and the second phase retardation element, the liquid-crystal layer comprising a chiral agent, wherein a pitch of the chiral agent is between 7 micrometers and 25 micrometers;
wherein the first phase retardation element has a first in-plane retardation value and a first out-plane retardation value, and the second phase retardation element has a second in-plane retardation value and a second out-plane retardation value, and wherein the first in-plane retardation value and the second in-plane retardation value are between 20 nanometers and 70 nanometers, and the first out-plane retardation value and the second out-plane retardation value are between 170 nanometers and 210 nanometers.

2. The electronic device as claimed in claim 1, wherein the first in-plane retardation value and the second in-plane retardation value are between 30 nanometers and 60 nanometers, and the first out-plane retardation value and the second out-plane retardation value are between 180 nanometers and 200 nanometers.

3. The electronic device as claimed in claim 1, wherein the pitch of the chiral agent is between 10 micrometers and 20 micrometers.

4. The electronic device as claimed in claim 1, wherein the first in-plane retardation value is the same as the second in-plane retardation value, and the first out-plane retardation value is the same as the second out-plane retardation value.

5. The electronic device as claimed in claim 1, further comprising:
a first polarizing layer disposed adjacent to the first phase retardation element; and
a second polarizing layer disposed adjacent to the second phase retardation element;
wherein the first phase retardation element comprises a first phase retardation layer and a second phase retardation layer, the second phase retardation element comprises a third phase retardation layer and a fourth phase retardation layer, the first phase retardation layer is located between the second phase retardation layer and the first polarizing layer, and the third phase retardation layer is located between the fourth phase retardation layer and the second polarizing layer.

6. The electronic device as claimed in claim 5, wherein the first phase retardation layer and the third phase retardation layer are formed of the same material, and the second phase retardation layer and the fourth phase retardation layer are formed of the same material.

7. The electronic device as claimed in claim 5, wherein the first phase retardation layer and the second phase retardation layer are formed of different materials.

8. The electronic device as claimed in claim 5, wherein the first phase retardation layer and the fourth phase retardation layer are formed of the same material, and the second phase retardation layer and the third phase retardation layer are formed of the same material.

9. The electronic device as claimed in claim 1, further comprising:
a first polarizing layer, wherein the first phase retardation element is disposed between the first polarizing layer and the liquid-crystal layer,
wherein the first phase retardation element comprises a first substrate, a first phase retardation layer and a second phase retardation layer, the first phase retardation layer is disposed between the first substrate and the liquid-crystal layer, and the second phase retardation layer is disposed between the first phase retardation layer and the liquid-crystal layer.

10. The electronic device as claimed in claim 9, further comprising:
a second polarizing layer, wherein the second phase retardation element is disposed between the second polarizing layer and the liquid-crystal layer,
wherein the second phase retardation element comprises a second substrate, a third phase retardation layer and a fourth phase retardation layer, the third phase retardation layer is disposed between the second substrate and the liquid-crystal layer, and the fourth phase retardation layer is disposed between the third phase retardation layer and the liquid-crystal layer.

11. The electronic device as claimed in claim 1, further comprising:
a first polarizing layer, wherein the first phase retardation element is disposed between the first polarizing layer and the liquid-crystal layer; and
a second polarizing layer, wherein the second phase retardation element is disposed between the second polarizing layer and the liquid-crystal layer;
wherein the first phase retardation element comprises a first substrate, a first phase retardation layer and a second phase retardation layer, and the first phase retardation layer and the second phase retardation layer are disposed between the first substrate and the liquid-crystal layer;
wherein the second phase retardation element comprises a second substrate, a third phase retardation layer and a fourth phase retardation layer, and the third phase retardation layer and the fourth phase retardation layer are disposed between the second substrate and the liquid-crystal layer.

12. The electronic device as claimed in claim 1, further comprising:
a first polarizing layer, wherein the first phase retardation element is disposed between the first polarizing layer and the liquid-crystal layer; and
a second polarizing layer, wherein the second phase retardation element is disposed between the second polarizing layer and the liquid-crystal layer;
wherein the first phase retardation element comprises a first substrate, a first phase retardation layer and a second phase retardation layer, and the first polarizing layer is disposed between the first phase retardation layer and the first substrate;
wherein the second phase retardation element comprises a second substrate, a third phase retardation layer and a fourth phase retardation layer, and the second polarizing layer is disposed between the second phase retardation layer and the second substrate.

13. The electronic device as claimed in claim 1, further comprising:
a first polarizing layer, wherein the first phase retardation element is disposed between the first polarizing layer and the liquid-crystal layer; and
a second polarizing layer, wherein the second phase retardation element is disposed between the second polarizing layer and the liquid-crystal layer;
wherein the first phase retardation element comprises a first substrate, a first phase retardation layer and a second phase retardation layer, and the first phase retardation layer and the second phase retardation layer are respectively disposed on both sides of the first substrate;
wherein the second phase retardation element comprises a second substrate, a third phase retardation layer and a fourth phase retardation layer, and the third phase retardation layer and the fourth phase retardation layer are respectively disposed on both sides of the second substrate.

14. The electronic device as claimed in claim 1, comprising:
a panel having a sub-pixel area, wherein the panel comprises a first substrate, a second substrate, a first electrode layer, and the liquid-crystal layer,
wherein the second substrate is opposite to the first substrate, the first electrode layer is disposed between the first substrate and the liquid-crystal layer, and the first electrode layer is correspondingly disposed in the sub-pixel area,
wherein the first electrode layer has a main portion and a plurality of branch portions, the main portion divides the first electrode layer into a first portion, a second portion, a third portion and a fourth portion, and an angle between one of the plurality of branch portions corresponding to the first portion and the main portion is between 40 degrees and 50 degrees.

15. The electronic device as claimed in claim 1, comprising:
a panel having a sub-pixel area, wherein the panel comprises a first substrate, a second substrate, a first electrode layer and the liquid-crystal layer,
wherein the second substrate is opposite to the first substrate, the first electrode layer is disposed between the first substrate and the liquid-crystal layer, and the first electrode layer is correspondingly disposed in the sub-pixel area,
wherein the first electrode layer has a main portion and a plurality of branch portions, and the main portion divides the first electrode layer into a first portion, a second portion, a third portion and a fourth portion, and a first included angle exists between one of the plurality of branch portions corresponding to the first portion and the main portion, a second included angle exists between one of the plurality of branch portions corresponding to the second portion and the main portion, and the first included angle is not equal to the second included angle.

16. The electronic device as claimed in claim 15, wherein a sum of the first included angle and the second included angle is between 80 degrees and 100 degrees.

17. The electronic device as claimed in claim 15, wherein one of the plurality of branch portions of the first portion and one of the plurality of branch portions of the second portion are symmetrical, when a short axis of the main portion is taken as a reference.

18. The electronic device as claimed in claim 15, wherein one of the plurality of branch portions of the first portion and one of the plurality of branch portions of the second portion are asymmetrical, when a long axis of the main portion is taken as a reference.

19. The electronic device as claimed in claim 1, wherein a product value of a birefringence (Δn) of the liquid-crystal layer and a thickness of the liquid-crystal layer is between 300 nanometers and 550 nanometers.

20. The electronic device as claimed in claim 1, wherein a ratio of the thickness to the pitch is between 0.15 and 0.35.
